(19) United States
(12) Patent Application Publication
(10) Pub. No.: US 2014/0347658 A1
(43) Pub. Date: Nov. 27, 2014

(54) SUPPORTING DEVICE

(71) Applicant: HON HAI PRECISION INDUSTRY CO., LTD., New Taipei (TW)

(72) Inventor: I-THUN LIN, New Taipei (TW)

(73) Assignee: HON HAI PRECISION INDUSTRY CO., LTD., New Taipei (TW)

(21) Appl. No.: 14/040,760

(22) Filed: Sep. 30, 2013

(30) Foreign Application Priority Data
May 27, 2013 (TW) 102118559

(51) Int. Cl. G01N 21/01

(52) U.S. Cl. CPC G01N 21/01
USPC 356/244

(57) ABSTRACT

A supporting device includes a stage, a level-meter assembly, a supporting pole, a first and second adjusting members. The stage includes a supporting plate having an upper surface and a lower surface, a first side plate, and a second side plate opposite to the first side plate. The two side plates extend from the lower surface. The first side plate includes a first surface facing away from the lower surface. The second side plate includes a second surface facing away from the lower surface. The second surface defines a first receiving hole and a second receiving hole. The level-meter assembly is mounted on the upper surface. The supporting pole is mounted on the first surface. A first extendable pole of the first adjusting member is received in the first receiving hole. A second extendable pole of the second adjusting member is received in the second receiving hole.

### BACKGROUND

1. Technical Field

The present disclosure relates to supporting devices.

2. Description of Related Art

In order to detect a quality of lens modules, a modulation transfer function (MTF) test is applied to a lens module supported on a supporting device. However, if a supporting surface of the supporting device is not completely level, an accurate result of the MTF test cannot be assured.

Therefore, it is desirable to provide a supporting device to overcome or at least alleviate the above-mentioned problems.

### BRIEF DESCRIPTION OF THE DRAWINGS

FIG. 1 is a schematic, isometric view of a supporting device, according to a first exemplary embodiment.

FIG. 2 is similar to FIG. 1, but viewed from another aspect.

FIG. 3 is a cross-sectional view of the supporting device of FIG. 1, taken along line III-III.

FIG. 4 is a cross-sectional view of the supporting device, according to a second exemplary embodiment.

### DETAILED DESCRIPTION

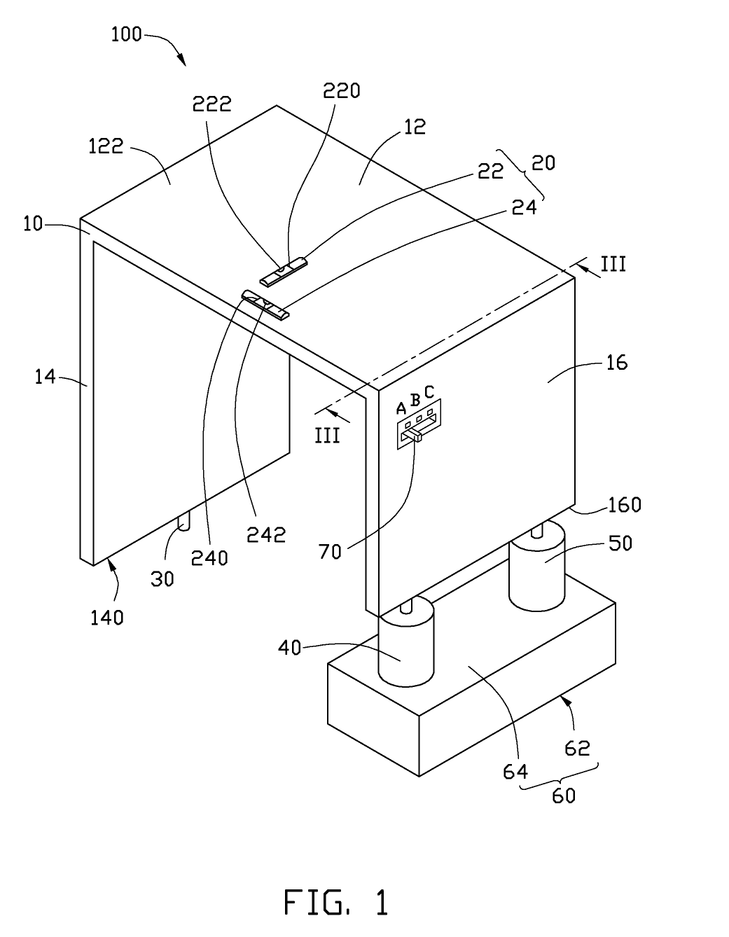

FIG. 1 shows a supporting device 100, according to a first exemplary embodiment. The supporting device 100 is configured to support a lens module (not shown). The supporting device 100 includes a stage 10, a level-meter assembly 20, a supporting pole 30, a first adjusting member 40, a second adjusting member 50, and a platform 60.

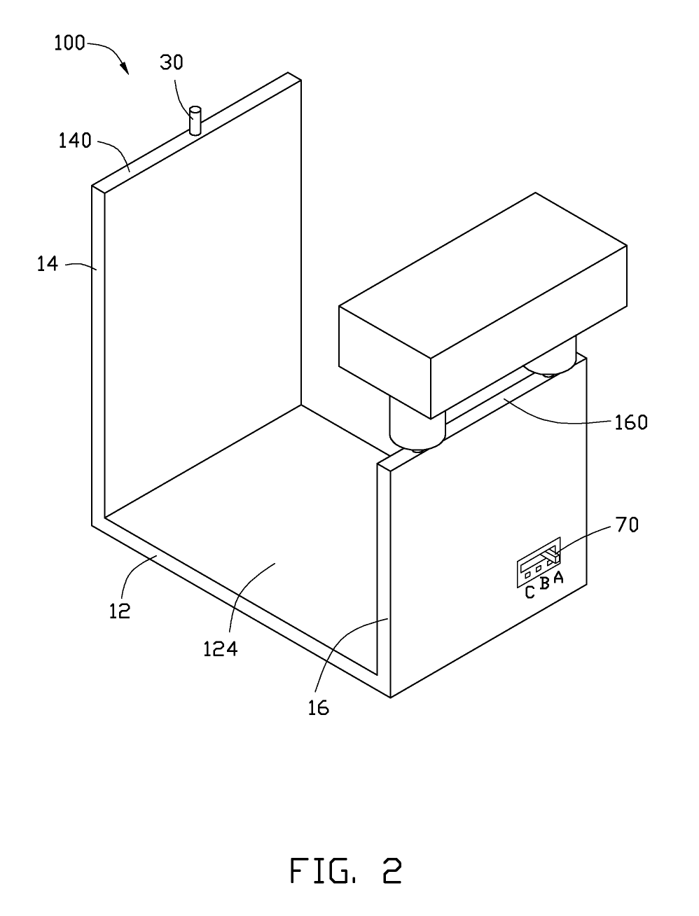

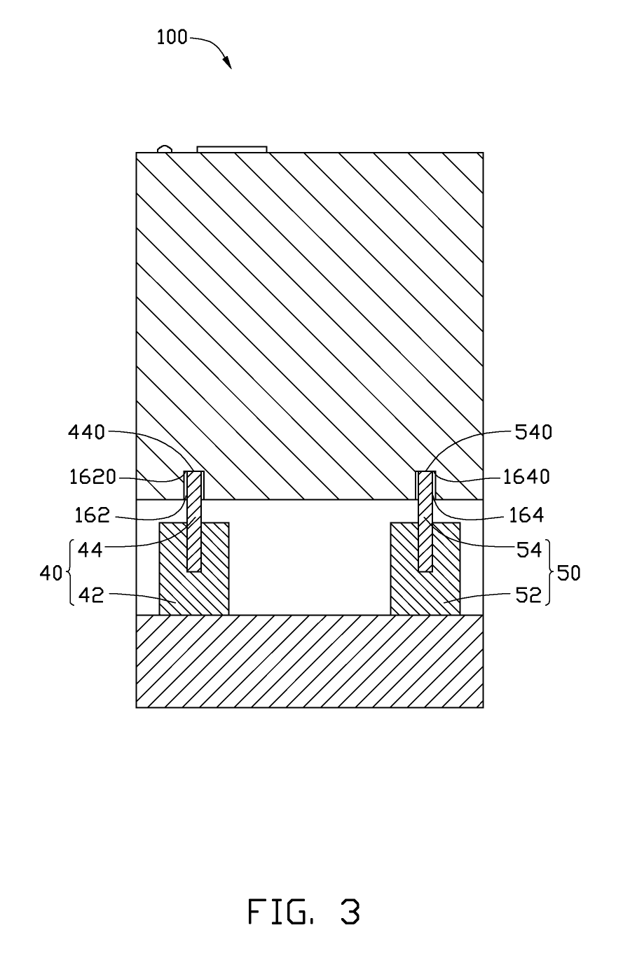

Referring to FIGS. 1-4, the stage 10 includes a supporting plate 12, a first side plate 14, and a second side plate 16. The supporting plate 12 includes an upper surface 122 and a lower surface 124. The upper surface 122 and the lower surface 124 are located at opposite sides of the supporting plate 12, and the upper surface 122 is substantially parallel to the lower surface 124. The first side plate 14 and the second side plate 16 extend substantially perpendicularly from the lower surface 124, and the first side plate 14 and the second side plate 16 are located at opposite ends of the supporting plate 12, respectively. The first side plate 14 includes a first surface 140 facing away from the bottom surface 124. The second side plate 16 includes a second surface 160 facing away from the bottom surface 124. The second surface 160 defines a first receiving hole 162 and a second receiving hole 164. The first receiving hole 162 and the second receiving hole 164 are spaced apart from each other. A first bottom 1620 of the first receiving hole 162 is a planar surface, and a second bottom 1640 of the second receiving hole 164 is a planar surface.

The level-meter assembly 20 is mounted on the upper surface 122. The level-meter assembly 20 includes a first level-meter 22 and a second level-meter 24. The first level-meter 22 is substantially perpendicular to the second level-meter 24, and the first level-meter 22 and the second level-meter 24 are spaced from each other. The first level-meter 22 includes two first scale marks 220 and a first bubble 222. The second level-meter 24 includes two second scale marks 240 and a second bubble 242. When the first bubble 222 is located in the middle of the two first scale marks 220, and the second bubble 242 is located in the middle of the two second scale marks 240, the upper surface 122 is completely level. Accordingly, a levelness of the lens module supported on the upper surface 122 is ensured.

The supporting pole 30 extends substantially perpendicularly from the first surface 140 away from the supporting plate 12. In this embodiment, the supporting pole 30 is substantially cylindrical.

The first adjusting member 40 is a piezoelectric motor. The first adjusting member 40 includes a first body 42 and a first extendable pole 44 protruding from the first body 42. The first extendable pole 44 is made of piezoelectric material. When a current is applied to the first extendable pole 44, the first extendable pole 44 mechanically deforms to stretch out from the first body 42 or to retract toward the first body 42. The first extendable pole 44 is controlled to stretch out and to retract by changing a direction of the current. The first extendable pole 44 includes a first top surface 440 facing away from the first body 42. The first top surface 440 is a planar surface.

The second adjusting member 50 is a piezoelectric motor. The second adjusting member 50 includes a second body 52 and a second extendable pole 54 protruding from the second body 52. The second extendable pole 54 is made of a piezoelectric material. When a current is applied to the second extendable pole 54, the second extendable pole 54 mechanically deforms to stretch out from the second body 52 or to retract toward the second body 52. The second extendable pole 54 includes a second top surface 540 facing away from the second body 52. The second top surface 540 is a planar surface.

The platform 60 is substantially cuboid. The platform 60 includes a contacting surface 62 and a supporting surface 64. The contacting surface 62 and the supporting surface 64 are located at opposite sides of the platform 60, and the contacting surface 62 is substantially parallel to the supporting surface 64.

In assembly of the supporting device 100, the first body 42 and the second body 52 are mounted on the supporting surface 64. The first extendable pole 44 is received in the first receiving hole 162, such that the first top surface 440 contacts the first bottom 1620. The second extendable pole 54 is received in the second receiving hole 164, such that the second top surface 540 contacts the second bottom 1640.

The supporting device 100 further includes a switch 70 electrically connected to the first adjusting member 40 and the second adjusting member 50. The switch 70 includes an A (left) position, a B (middle) position, and a C (right) position. When the switch 70 is at the B position, the first adjusting member 40 and the second adjusting member 50 are inactivated. When the switch 70 is at the A position, the second switch 50 remains inactivated, the first adjusting member 40 is activated, and the second side plate 16 moves upward or downward along with the movement of the first extendable pole 44. When the switch 70 is at the C position, the first switch 40 is inactivated, the second adjusting member 50 is activated, and the second side plate 16 moves upward or downward along with the movement of the second extendable pole 54.

When in use, the supporting device 100 is placed on a surface. If the surface is not completely level, a current is applied to the first adjusting member 40 or the second adjusting member 50 to adjust a level of the upper surface 122. For example, when the first adjusting member 40 needs to be adjusted, a current is applied to the first adjusting member 40, and the first extendable pole 44 deforms to stretch out from the first body 42 or to retract toward the first body 42, thereby causing the second side plate 16 to move upward or downward. The supporting pole 30 and a joint between the second bottom 1640 and the second top surface 540 serve as two fulcrums. The current is turned off when the first bubble 222 is located in the middle of the two first scale marks 220, and the second bubble 242 is located in the middle of the two second scale marks 240. When the first bubble 222 is located in the middle of the two first scale marks 220, and the second bubble 242 is located in the middle of the two second scale marks 240, the upper surface 122 is completely level. Therefore, when the lens module is placed on the upper surface 122, the lens module is completely level. The second adjusting member 50 is adjusted similarly to the first adjusting member 40. The current is alternately applied to the first adjusting member 40 and the second adjusting member 50 until the first bubble 222 is located in the middle of the two first scale marks 220, and the second bubble 242 is located in the middle of the two second scale marks 240.

During the MTF testing process, if the supporting device 100 is placed on a non-level surface, the upper surface 122 supporting the lens module is adjusted to be completely level. Thus, the levelness of the lens module is ensured, and an accurate result of the MTF test is assured.

In other embodiments, the platform 60 can be omitted, such that the first body 42 and the second body 52 are directly placed on the surface.

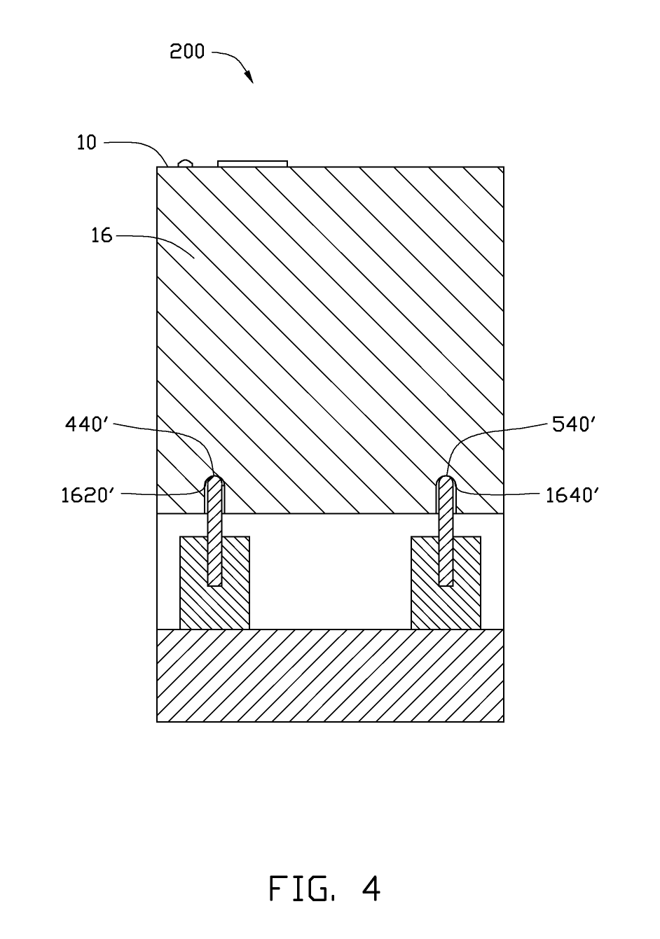

FIG. 4 shows a supporting device 200 according to a second exemplary embodiment. The differences between the supporting device 200 of the second embodiment and the supporting device 100 are that: a first bottom 1620′ and a second bottom 1640′ are spherical surfaces. A first top surface 440′ is a spherical surface corresponding to the first bottom 1620′, and a second top surface 540′ is a spherical surface corresponding to the second bottom 1640′.

Advantages of the supporting device 200 of the second embodiment are similar to those of the supporting device 100 of the first embodiment. In addition, the stage 10 is steadier when the second side plate 16 moves upward and downward because of the increases surface contact between the first bottom 1620′ and the first top surface 440′, and between the second bottom 1640′ and the second top surface 540′.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A supporting device comprising:
a stage comprising a supporting plate, a first side plate and a second side plate, the supporting plate comprising an upper surface and a lower surface opposite to the upper surface, the first side plate and the second side plate perpendicularly extending from the lower surface and positioned at opposite sides of the supporting plate, the first side plate comprising a first surface facing away from the lower surface, the second side plate comprising a second surface facing away from the lower surface, the second surface defining a first receiving hole and a second receiving hole spaced apart from the first receiving hole;
a level-meter assembly mounted on the upper surface and configured to show the levelness of the upper surface;
a supporting pole mounted on the first surface;
a first adjusting member comprising a first body and a first extendable pole protruding from the first body, the first extendable pole received in the first receiving hole; and
a second adjusting member comprising a second body and a second extendable pole protruding from the second body, the second extendable pole received in the second receiving hole, and wherein the second side plate is movable with the movement of the first extendable pole and/or the second extendable pole, thereby adjusting the levelness of the upper surface within a predetermined levelness range.

2. The supporting device of claim 1, wherein each of the first extendable pole and the second extendable pole is made of piezoelectric material.

3. The supporting device of claim 2, wherein the first receiving hole comprises a first bottom, the second receiving hole comprises a second bottom, the first extendable pole comprises a first top surface, the second extendable pole comprises a second top surface, the first top surface contacts the first bottom, and the second top surface contacts the second bottom.

4. The supporting device of claim 3, wherein each of the first bottom and the second bottom is a planar surface, and each of the first top surface and the second top surface is a planar surface.

5. The supporting device of claim 3, wherein each of the first bottom and the second bottom is a spherical surface, and each of the first top surface and the second top surface is a spherical surface.

6. The supporting device of claim 3, wherein the first bottom is a planar surface, the first top surface is a planar surface, the second bottom is a spherical surface, and the second top surface is a spherical surface.

7. The supporting device of claim 3, wherein the first bottom is a spherical surface, the first top surface is a spherical surface, the second bottom is a planar surface, and the second top surface is a planar surface.

8. The supporting device of claim 1, further comprising a platform, wherein the first body and the second body are mounted on the platform.

9. The supporting device of claim 1, wherein the level-meter assembly comprises a first level-meter and a second level-meter, and the first level-meter is substantially perpendicular to the second level-meter.

10. The supporting device of claim 1, further comprising a switch, wherein the switch is electrically connected to the first adjusting member and the second adjusting member and is configured to active or inactive the first adjusting member and the second adjusting member.
